(19) United States
(12) Patent Application Publication
(10) Pub. No.: US 2012/0115548 A1
(43) Pub. Date: May 10, 2012

(54) Mobile communication base station antenna and mobile communication base station antenna system

(75) Inventors: Takayuki Shimizu, Hitachi (JP); Shinsuke Murano, Kasama (JP); Ryota Suzuki, Tokai-mura (JP); Osamu Tasaki, Hitachi (JP); Tomoyuki Ogawa, Hitachi (JP)

(73) Assignee: HITACHI CABLE, LTD., Tokyo (JP)

(21) Appl. No.: 13/064,235

(22) Filed: Mar. 11, 2011

(30) Foreign Application Priority Data
Nov. 9, 2010 (JP) 2010-250459

(51) Int. Cl. H04W 88/08

(52) U.S. Cl. 455/562.1

(57) ABSTRACT

A mobile communication base station antenna has two array antennas juxtaposed in a horizontal direction. Each of the array antennas includes a plurality of antenna element pairs arranged in a vertical direction. Each of the antenna element pairs includes two antenna elements having polarization characteristics perpendicular to each other. A shield plate is provided between the two array antennas. The plurality of antenna element pairs of each of the two array antennas are classified into a first group of M-antenna element pairs, a second group of N-antenna element pairs, and a third group of P-antenna element pairs from one end to another end of the two array antennas (M, N, and P are positive integers, respectively). The electric power is fed from one feeding point to the antenna elements of the first and third group of one of the two array antennas and the antenna elements of the second group of another of the two array antennas, and a tilt angle of the two array antennas with respect to a horizontal plane is set to be a predetermined tilt angle by electrical tilting.

The present application is based on Japanese Patent Application No. 2010-250459 filed on Nov. 9, 2010, the entire contents of which are incorporated herein by reference.

### BACKGROUND OF THE INVENTION

1. Field of the Invention

The present invention relates to a mobile communication base station antenna and a mobile communication base station antenna system.

2. Related Art

Techniques such as Frequency Division Multiple Access (FDMA), Time Division Multiple Access (TDMA), and Code Division Multiple Access (CDMA) have been proposed to realize a simultaneous connection of plural users in a base station to be used for mobile communication, and have been introduced into commercial systems.

However, as a result of sudden increase of mobile communication users in accordance with spread of the mobile communication for late years, there is a problem in that the number of frequencies becomes short due to call requests more than capacity of frequency channels assigned to the mobile communication system.

Therefore, the Space Division Multiple Access (SDMA), which realizes the communication with the users in one (single) frequency band, has been proposed so as to realize expansion of the channel capacity by increasing a utilization efficiency of the frequency. In the SDMA, the plural users are separated by difference in space, by turning a main beam orientation of a directivity of a base station antenna toward a desired user and turning a null orientation of the directivity of the base station antenna toward other users.

As a technique for realizing the SDMA, there is a radio communication technique called as MIMO (Multiple Input Multiple Output), in which a data transmission and reception band is broadened by combining plural antennas. In the MIMO, it is necessary to install plural antennas for dividing a transmission data into plural signals (streams) and simultaneously transmitting the divided signals.

Japanese Patent Laid-Open No. 2001-313525 (JP-A 2001-313525) proposes a mobile communication base station antenna for realizing the SDMA, in which plural array antennas are located linearly (on a straight line) or annularly (on a circumference of a circle) so as to improve resolution capability of the plural users.

In addition, K. Nishimori et al, “Channel Capacity Measurement of 8×2 MIMO Transmission by Antenna Configurations in an Actual Cellular Environment”, IEEE TRANSACTIONS ON ANTENNAS AND PROPAGATION, VOL. 54, No. 11, November, 2006, pp. 3285-3291 proposes a mobile communication base station for realizing the SDMA, in which four array antennas using V-H (vertical and horizontal) polarized waves and ±45 degree slant polarized wave are arranged in a horizontal direction.

### SUMMARY OF THE INVENTION

However, in the conventional antenna devices proposed by JP-A 2001-313525 and Nishimori et al, there is a problem in that an installation occupied area of the mobile communication base station antenna in total is increased since the array antennas are disposed linearly or annularly on a circumference.

In late years, in accordance with spread of radio communication including portable telephone, a lot of the mobile communication base station antennas are installed all over the town. However, since the mobile communication base station antenna is generally installed on a steel tower or a roof of a high building, the increase in the occupation area not only raises the cost for installation but also damages the landscape, so that it is unfavorable to increase the occupation area of the mobile communication base station antenna.

Therefore, it is indispensable to introduce the MIMO by arranging the plural array antennas so as to increase the channel capacity by improving the utilization efficiency of the frequency. However, since there is a request of avoiding the increase in the installation occupied area as much as possible, the mobile communication base station antenna with a small installation occupied area is strongly desired.

Further, in the case that new high-rise buildings and new base stations are constructed in the residential area where buildings are jumbled up close together or the district with immaculately set areas, the location where the leak and interference of the radio wave is hardly prevented will be generated.

Accordingly, it is an object of the invention to provide a mobile communication base station antenna and a mobile communication base station antenna system which can prevent the leak and interference of the radio wave.

According to a first feature of the invention, a mobile communication base station antenna comprises:

two array antennas juxtaposed in a horizontal direction, each of the array antennas including a plurality of antenna element pairs arranged in a vertical direction, each of the antenna element pairs comprising two antenna elements having polarization characteristics perpendicular to each other; and

a shield plate provided between the two array antennas;

in which the plurality of antenna element pairs of each of the two array antennas are classified into a first group comprising M-antenna element pairs, a second group comprising N-antenna element pairs, and a third group comprising P-antenna element pairs from one end to another end of the two array antennas (M, N, and P are positive integers, respectively),

in which an electric power is fed from one feeding point to the antenna elements of the first and third group of one of the two array antennas and the antenna elements of the second group of another of the two array antennas,

in which a tilt angle of the two array antennas with respect to a horizontal plane is set to be a predetermined tilt angle by electrical tilting.

In the mobile communication base station antenna, the tilt angle may be 10° or more.

In the mobile communication base station antenna, the shield plate may have a height greater than a height of the antenna element pairs.

In the mobile communication base station antenna, the shield plate may be formed by using a wave absorber.

According to another feature of the invention, a mobile communication base station antenna system, configured to receive a signal at a predetermined frequency from a predetermined service area, comprises:

a mobile communication base station antenna comprising:

two array antennas juxtaposed in a horizontal direction, each of the array antennas including a plurality of antenna element pairs arranged in a vertical direction, each of the antenna element pairs comprising two antenna elements having polarization characteristics perpendicular to each other; and

a shield plate provided between the two array antennas;

in which the plurality of antenna element pairs of each of the two array antennas are classified into a first group comprising M-antenna element pairs, a second group comprising N-antenna element pairs, and a third group comprising P-antenna element pairs from one end to another end of the two array antennas (M, N, and P are positive integers, respectively),

in which an electric power is fed from one feeding point to the antenna elements of the first and third group of one of the two array antennas and the antenna elements of the second group of another of the two array antennas,

in which a tilt angle of the two array antennas with respect to a horizontal plane is set to be a predetermined tilt angle by electrical tilting.

In the mobile communication base station antenna system, the tilt angle of the mobile communication base station antenna may be set to be a predetermined tilt angle by the electric tilt such that a transmit and receive signal intensity for the service area in a front direction of the mobile communication base station antenna is suppressed and a transmit and receive signal intensity of a region except the service area in the front direction is not suppressed.

In the mobile communication base station antenna system, the tilt angle may be set to be a predetermined angle such that a plurality of propagation paths for the signal are formed.

### Advantages of the Invention

According to the present invention, it is possible to provide a mobile communication base station antenna and a mobile communication base station antenna system which can prevent the leak and interference of the radio wave.

### Points of the Invention

In the present invention, a plurality of antenna element pairs are classified into a first group comprising M-antenna element pairs, a second group comprising N-antenna element pairs, and a third group comprising P-antenna element pairs from one end to another end of each of first and second array antennas (M, N, and P are positive integers, respectively), and an electric power is fed to the antenna elements of the first and third group of the first array antenna and the antenna elements of the second group of the second array antenna, and a tilt angle of each of the first and second array antennas with respect to a horizontal plane is set to be a predetermined tilt angle by electrical tilting. According to this structure, the electric power can be divided and fed to the respective antenna1 elements with a good balance, so that it is possible to radiate the beam including side lobes toward a front direction of the mobile communication base station antenna with a good balance. Therefore, it is possible to prevent the leak and interference of the electric wave while keeping the symmetry of transmit and receive signal intensity distribution of the main beam in the horizontal plane along the front direction.

### BRIEF DESCRIPTION OF THE DRAWINGS

Next, the mobile communication base station antenna and the mobile communication base station antenna system in an embodiment according to the invention will be explained in conjunction with appended drawings, wherein:

FIG. 1A is a perspective view of a mobile communication base station antenna in an embodiment according to the invention;

FIG. 1B is a front view of the mobile communication base station antenna in the embodiment according to the invention;

FIG. 1C is a bottom view of the mobile communication base station antenna in the embodiment according to the invention;

FIG. 1D is a perspective view of a single body of a vertical polarized wave antenna element;

FIG. 1E is a perspective view of a single body of a horizontal polarized wave antenna element;

FIG. 1F is a schematic diagram showing an essential structure of the mobile communication base station antenna in the embodiment according to the invention;

FIG. 2A is a schematic diagram showing a mobile communication base station antenna without shield plate;

FIG. 2B is a schematic diagram showing a mobile communication base station antenna with a shield plate;

FIG. 3A is a schematic diagram showing a mobile communication base station antenna with a single shield plate;

FIG. 3B is a schematic diagram showing a mobile communication base station antenna with two shield plates;

FIG. 4 is a graph showing directivities in a horizontal plane of the mobile communication base station antenna having different cut plane in the embodiment according to the present invention;

FIG. 5A is a graph showing a received signal power in a horizontal plane when 10-element array antennas in the embodiment are aligned along a straight line to have a tilt angle of 4°;

FIG. 5B is a graph showing a received signal power in the horizontal plane when the 10-element array antennas in the embodiment are aligned along a straight line to have a tilt angle of 9°;

FIG. 5C is a graph showing a received signal power in the horizontal plane when the 10-element array antennas in the embodiment are aligned along a straight line to have a tilt angle of 12°;

FIG. 5D is a graph showing a received signal power intensity distribution in the horizontal plane when the 10-element array antennas in the embodiment are classified into plural groups (M=3, N=4, and P=3) on right and left sides respectively to have a tilt angle of 4°;

FIG. 5E is a graph showing a received signal power intensity distribution in the horizontal plane when the 10-element array antennas in the embodiment are classified into plural groups (M=3, N=4, and P=3) on right and left sides respectively to have a tilt angle of 9°;

FIG. 5F is a graph showing a received signal power intensity distribution in the horizontal plane when the 10-element array antennas in the embodiment are classified into plural groups (M=3, N=4, and P=3) on right and left sides respectively to have a tilt angle of 12°;

FIG. 6A is a schematic diagram showing a perspective view of a service area on the ground;

FIG. 6B is a schematic diagram showing a perspective view of a service area on the ground;

FIG. 6C is a schematic diagram showing a perspective view of a service area on the ground;

FIG. 6D is a schematic diagram showing a perspective view of a service area on the ground;

FIG. 7 is a schematic diagram showing an essential structure of a mobile communication base station antenna in a reference example 1;

FIG. 8 is a graph showing directivities in a horizontal plane of the mobile communication base station antenna in the reference example 1;

FIG. 9 is a schematic diagram showing an essential structure of a mobile communication base station antenna in a reference example 2; and

FIG. 10 is a graph showing directivities in a horizontal plane of the mobile communication base station antenna in the reference example 2.

### DETAILED DESCRIPTION OF THE EMBODIMENT

Next, the embodiment according to the present invention will be explained below in more detail in conjunction with appended drawings.

### Embodiment

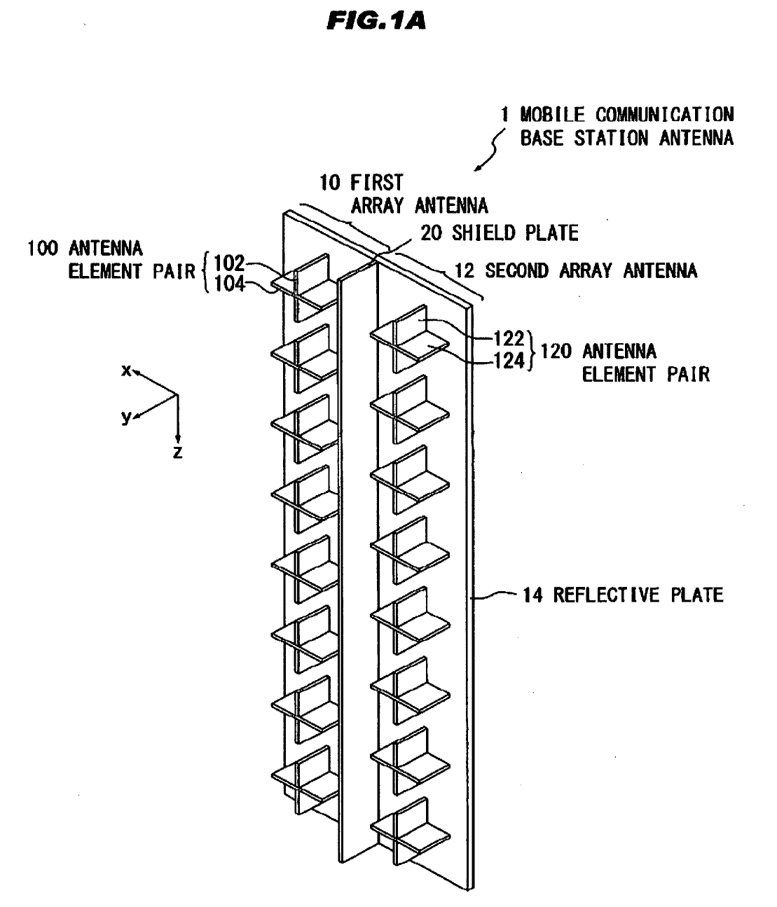

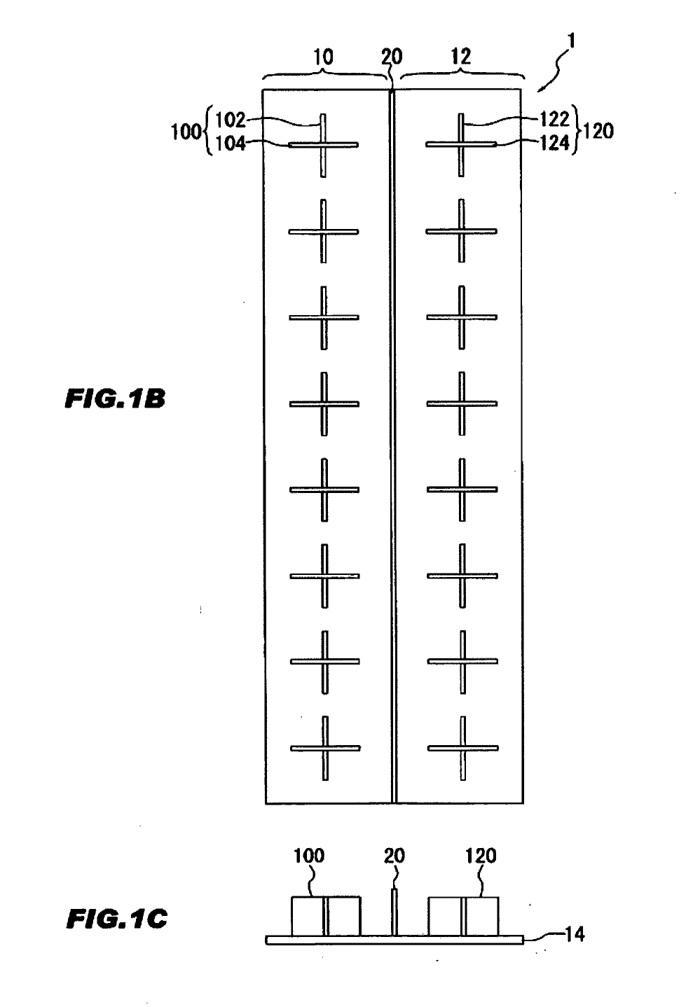

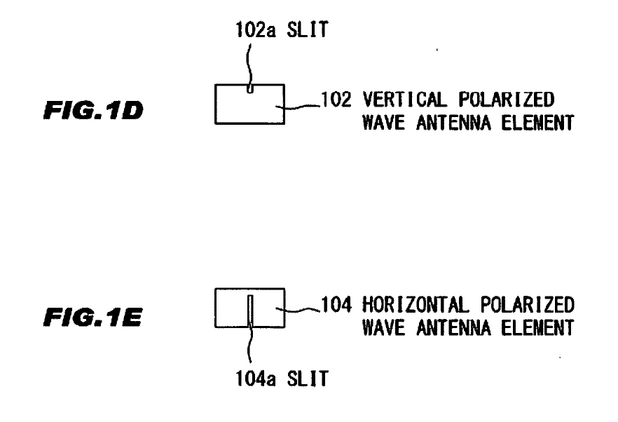

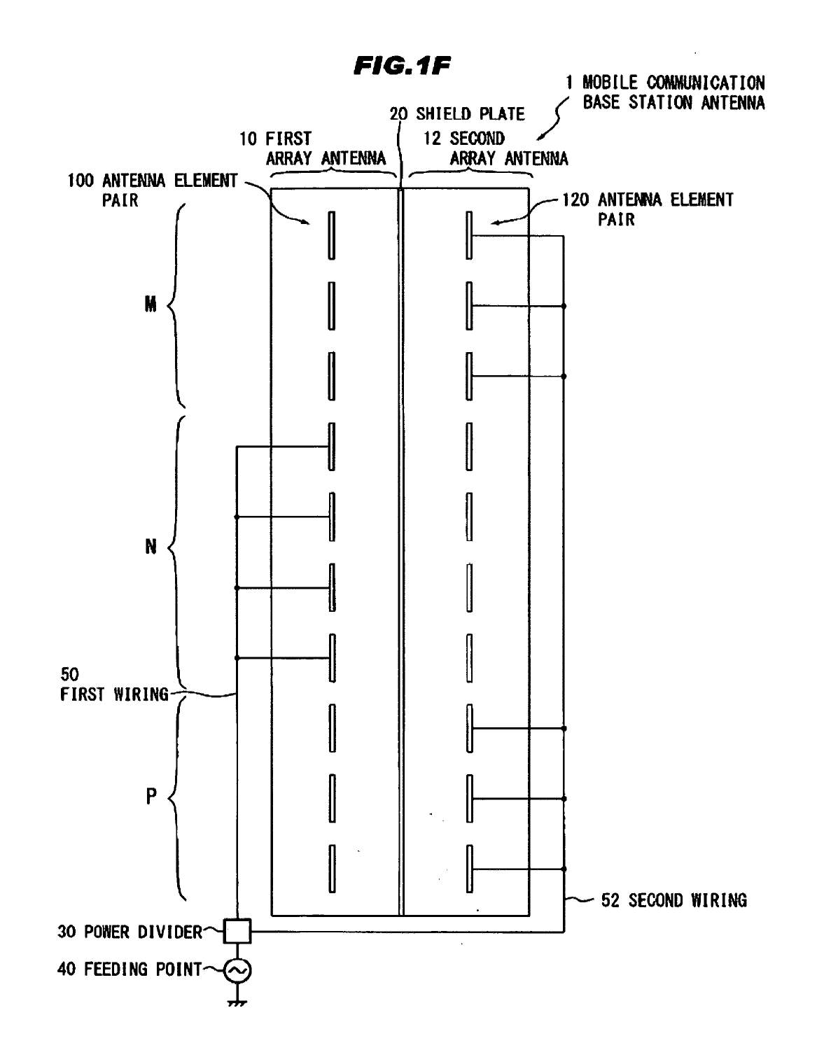

FIG. 1A is a perspective view of a mobile communication base station antenna in an embodiment according to the invention. FIG. 1B is a front view of the mobile communication base station antenna in the embodiment according to the invention. FIG. 1C is a bottom view of the mobile communication base station antenna in the embodiment according to the invention. FIG. 1D is a perspective view of a single body of a vertical polarized wave antenna element. FIG. 1E is a perspective view of a single body of a horizontal polarized wave antenna element. FIG. 1F is a schematic diagram showing an essential structure of the mobile communication base station antenna in the embodiment according to the invention.

A mobile communication base station antenna 1 in the embodiment is used for e.g. SDMA (Space Division Multiplex Access) communication. For example, the mobile communication base station antenna 1 is applied to a radio communication technique called as Multiple Input Multiple Output (MIMO) for enlarging a channel capacity by means of a plurality of antennas. In the MIMO, a transmission data is divided into a plurality of signal data and transmitted at the same time (simultaneously). Therefore, in the MIMO, it is demanded that the plurality of antennas are installed. In this embodiment, the plurality of antenna are installed by arranging a first array antenna 10 and a second array antenna 12 provided in the mobile communication base station antenna 1 to be juxtaposed in a horizontal direction (x-direction in FIG. 1A, namely in a width direction with respect to a front surface of a reflective plate 14).

In this embodiment, a mobile communication base station antenna 1 comprises two array antennas 10, 12 juxtaposed in a horizontal direction, each of the array antennas 10, 12 including a plurality of antenna element pairs 100, 120 arranged in a vertical direction, each of the antenna element pairs 100, 120 comprising two antenna elements 102 or 122 and 104 or 124 having polarization characteristics perpendicular to each other, and a shield plate 20 provided between the two array antennas 10, 12, in which the plurality of antenna element pairs 100, 120 of each of the two array antennas 10, 12 are classified into a first group comprising M-antenna element pairs, a second group comprising N-antenna element pairs, and a third group comprising P-antenna element pairs from one end to another end of the two array antennas 10, 12 (M, N, and P are positive integers, respectively), in which an electric power is fed from one feeding point 40 to the antenna elements 102 and 104 of the first and third group of one of the two array antennas 10 and the antenna elements 122 and 124 of the second group of another of the two array antennas 12, in which a tilt angle of the two array antennas 10, 12 with respect to a horizontal plane is set to be a predetermined tilt angle by electrical tilting.

(Structure of the Mobile Communication Base Station Antenna 1)

More concretely, the mobile communication base station antenna 1 in this embodiment comprises the first array antenna 10 having a rectangular shape in its front view and the second array antenna 12 having a rectangular shape in its front view that is juxtaposed with the first array antenna 10 in a horizontal direction of the first array antenna 10 (i.e. the x-direction of FIG. 1A). The first array antenna 10 includes eight (8)-antenna element pairs 100, each of which comprises a vertical polarized wave antenna element 102 and a horizontal polarized wave antenna element 104 polarization characteristic of which are perpendicular to each other. In a like manner, the second array antenna 12 includes eight (8)-antenna element pairs 120, each of which comprises a vertical polarized wave antenna element 122 and a horizontal polarized wave antenna element 124 polarization characteristic of which are perpendicular to each other. The antenna element pairs 100 and the antenna element pairs 120 are arranged linearly in a vertical direction (z-direction in FIG. 1A, namely in a longitudinal direction of a front surface of the reflective plate 14) of the mobile communication base station antenna 1, respectively.

The vertical polarized wave antenna element 102 and the horizontal polarized wave antenna element 104 are combined with each other at a substantially center portion of each antenna element to provide the antenna element pair 100. The vertical polarized wave antenna element 102 and the horizontal polarized wave antenna element 104 are combined with each other to have a cruciform cross section. In a like manner, the vertical polarized wave antenna element 122 and the horizontal polarized wave antenna element 124 are combined with each other at a substantially center portion of each antenna element to provide the antenna element pair 120.

More concretely, referring to FIG. 1D, the vertical polarized wave antenna element 102 is formed in a rectangular shape in its front view, and has a slit 102a which extends from a region including a substantially center point of one long side toward the other long side. Referring to FIG. 1E, the horizontal polarized wave antenna element 104 is formed in a rectangular shape in a front view, and has a slit 104a, which has a substantially equal width to that of the slit 102a and a length longer that that of the slit 102a and extends from a region including a substantially center point of one long side toward the other long side. The antenna element pair 100 is formed by fitting the slit 104a into the slit 102a. Since the antenna element pair 100 is formed similarly to the antenna element pair 120, detailed description thereof is omitted.

The antenna element pair 100 uses both of a radio wave polarized by the vertical polarized wave antenna element 102 and a radio wave polarized by the horizontal polarized wave antenna element 104 to transmit and/or receive signals. In a like manner, the antenna element pair 120 uses both of a radio wave polarized by the vertical polarized wave antenna element 122 and a radio wave polarized by the horizontal polarized wave antenna element 124 to transmit and/or receive signals.

In addition, the mobile communication base station antenna 1 comprises the reflective plate 14 equipped with the first array antenna 10 and the second array antenna 12. Referring to FIG. 1C, the mobile communication base station antenna 1 comprises a shield plate 20 is provided to be positioned between the first array antenna 10 and the second array antenna 12. The shield plate 20 is formed by using a conductor such as metallic material. The shield plate 20 is provided to extend along a normal orientation (y-direction in FIG. 1A) of the front surface (a surface on which the first array antenna 10 and the second array antenna 12 are directly installed) of the reflective plate 14.

Referring to FIG. 1C, the shield plate 20 has a height greater than a height of the antenna element pairs 100 and a height of the antenna element pairs 120 (namely a distance from the front surface of the reflective plate 14 with which the antenna element pairs 100 and the antenna element pairs 120 come into contact to tip ends of the antenna element pair 100 and the antenna element pair 120 on a side opposite to the front surface of the reflective plate 14), for the purpose of suppressing electric interference between the antenna element pairs 100 and the antenna element pairs 120 disposed adjacent to the antenna element pairs 100. In addition, the shield plate 20 may be formed by using a wave absorber such as magnetic substance or dielectric material.

In addition, a printed dipole radio antenna may be used for the vertical polarized wave antenna element 102, the horizontal polarized wave antenna element 104, the vertical polarized wave antenna element 122 and the horizontal polarized wave antenna element 124, respectively. More concretely, each of the vertical polarized wave antenna element 102, the horizontal polarized wave antenna element 104, the vertical polarized wave antenna element 122 and the horizontal polarized wave antenna element 124 comprises a dielectric substrate having a substantially rectangular shape in its front view, a dipole element provided on the rectangular dielectric substrate, a feeding line conductor, and a setting conductor, and the like. For example, a rod-shape dipole antenna or a dipole antenna formed by folding a metal plate may be used for the vertical polarized wave antenna element 102, the horizontal polarized wave antenna element 104, the vertical polarized wave antenna element 122 and the horizontal polarized wave antenna element 124, respectively.

FIG. 1F shows an essential structure of the mobile communication base station antenna in this embodiment.

For illustration purposes, the horizontal polarized wave antenna element 104 and the horizontal polarized wave antenna element 124 as well as one feeding point, a feeding port and a power divider for feeding electric power to the horizontal polarized wave antenna element 104 and the horizontal polarized wave antenna element 124 are omitted in FIG. 1F.

The mobile communication base station antenna 1 further comprises one feeding point 40 which feeds electric power to the vertical polarized wave antenna element 102 of each of the antenna element pairs 100 and the vertical polarized wave antenna element 122 of each of the antenna element pairs 120, a feeding point (not shown) which feeds electric power to the horizontal polarized wave antenna element 104 of each of the antenna element pairs 100 and the horizontal polarized wave antenna element 124 of each of the antenna element pairs 120, a power divider 30 which distributes the electric power from the feeding point 40 to the vertical polarized wave antenna element 102 of each of the antenna element pairs 100 and the vertical polarized wave antenna element 122 of each of the antenna element pairs 120, and a power divider (not shown) which distributes the electric power from the feeding point (not shown) to the horizontal polarized wave antenna element 104 of each of the antenna element pairs 100 and the horizontal polarized wave antenna element 124 of each of the antenna element pair 120.

Further, the mobile communication base station antenna 1 further comprises a wiring 50 and a wiring 52 for feeding the electric power which is fed from the feeding point 40 and distributed (divided) by the power divider 30 to predetermined antenna elements, more concretely, respective antenna elements classified in a first group comprising M-antenna element pairs, a second group comprising N-antenna element pairs, and a third group comprising P-antenna element pairs to be described later. In a like manner, the mobile communication base station antenna 1 further comprises a plurality of wirings for feeding the electric power which is fed from the feeding point (not shown) and distributed by the power divider (not shown) to predetermined antenna elements, more concretely, respective antenna elements classified in a first group comprising M-antenna element pairs, a second group comprising N-antenna element pairs, and a third group comprising P-antenna element pairs.

The antenna element pairs 100 of the first array antenna 10 and the antenna element pairs 120 of the second array antenna 12 are respectively classified into the first group comprising M-antenna element pairs, the second group comprising N-antenna element pairs, and the third group comprising P-antenna element pairs from one end to another end of each of the first array antenna 10 and the second array antenna 12 (M, N, and P are positive integers, respectively).

Then, the electric power is fed from the feeding point 40 to the antenna elements in the first group comprising M-antenna element pairs, the second group comprising N-antenna element pairs, and the third group comprising P-antenna element pairs, respectively. For example, the electric power is fed from the feeding point 40 to the vertical polarized wave antenna elements 122 of the first group comprising M-antenna element pairs and the vertical polarized wave antenna elements 122 of the third group comprising P-antenna element pairs of the second array antenna 12 via the power divider 30 and the wiring 52. On the other hand, the electric power is fed from the feeding point 40 to the vertical polarized wave antenna elements 102 of the second group comprising N-antenna element pairs of the first array antenna 10 via the power divider 30 and the wiring 50.

Further, the electric power is fed from the feeding point (not shown) to the vertical polarized wave antenna elements 122 of the second group comprising N-antenna element pairs of the second array antenna 12 via the power divider (not shown) and the wiring (not shown). On the other hand, the electric power is fed from the feeding point (not shown) to the vertical polarized wave antenna elements 102 of the first group comprising M-antenna element pairs and the vertical polarized wave antenna elements 102 of the third group comprising P-antenna element pairs of the first array antenna 10 via the power divider (not shown) and the wiring (not shown).

Similarly, the electric power may be fed from a feeding point (not shown) to the horizontal polarized wave antenna elements 104 of the antenna element pairs 100 of the first array antenna 10 and the horizontal polarized wave antenna elements 124 of the antenna element pairs 120 of the second array antenna 12 via a power divider (not shown) and wirings (not shown). For example, the electric power may be fed from the feeding point (not shown) to the horizontal polarized wave antenna elements 104 of the first group comprising M-antenna element pairs and the horizontal polarized wave antenna elements 104 of the third group comprising P-antenna element pairs of the first array antenna 10 via the power divider (not shown) and the wiring (not shown). On the other hand, the electric power may be fed from the feeding point (not shown) to the horizontal polarized wave antenna elements 124 of the second group comprising N-antenna element pairs of the second array antenna 12 via the power divider (not shown) and the wiring (not shown). Further, the electric power may be fed from the feeding point (not shown) to the horizontal polarized wave antenna elements 104 of the second group comprising N-antenna element pairs of the first array antenna 10 via the power divider (not shown) and the wiring (not shown). On the other hand, the electric power may be fed from the feeding point (not shown) to the horizontal polarized wave antenna elements 124 of the first group comprising M-antenna element pairs and the horizontal polarized wave antenna elements 124 of the third group comprising P-antenna element pairs of the second array antenna 12 via the power divider (not shown) and the wiring (not shown).

In other words, the antenna element pairs 120 of the first array antenna 10 and the antenna element pairs 100 of the second array antenna 12 are divided into groups each of which comprises a predetermined number of the antenna element pairs. Positions of respective groups are divided (classified) into right and left sides in the front view of the mobile communication base station antenna 1 with respect to the shield plate 20 as a symmetric axis, and the electric power is distributed to the respective groups divided into the right and left sides.

In this embodiment, the groups of the antenna elements to which the electric power is supplied from one feeding point (e.g. the feeding point 40) are classified into the first group comprising M-antenna element pairs, the second group comprising N-antenna element pairs, and the third group comprising P-antenna element pairs from one end to another end, and the first group comprising M-antenna element pairs at the one end and the third group comprising P-antenna element pairs at the other end are positioned on the right side with respect to the shield plate 20 in the front view of the mobile communication base station antenna 1, while the second group comprising N-antenna element pairs sandwiched between the first group comprising M-antenna element pairs at the one end and the third group comprising P-antenna element pairs is are positioned on the left side with respect to the shield plate 20 in the front view of the mobile communication base station antenna 1 The groups of the antenna elements to which the electric power is supplied from another feeding point (not) are positioned similarly to the above arrangement.

As an example, when the number of the antenna element pairs 100 of the first array antenna 10 and the number of antenna element pairs 120 of the second array antenna 12 are ten (10) respectively, M, N, and P may be set as M=3, N=4, and P=3, respectively. When the number of the antenna element pairs 100 of the first array antenna 10 and the number of antenna element pairs 120 of the second array antenna 12 are eight (8) respectively, M, N, and P may be set as M=2, N=4, and P=2, respectively. When the number of the antenna element pairs 100 of the first array antenna 10 and the number of antenna element pairs 120 of the second array antenna 12 are eight (7) respectively, M, N, and P may be set as M=2, N=3, and P=2, respectively.

In addition, it is preferable that relationships between M, N and P satisfy following conditions.

First of all, it is preferable that N is generally or substantially equal to a total of M and P (i.e. N≈M+P) and M is generally or substantially equal to N (i.e. M≈N) for the purpose of creating a better balance (namely, equilibrating) on the right and left sides of a horizontal plane directivity of the mobile communication base station antenna 1

Furthermore, the mobile communication base station antenna 1 in this embodiment has a function of tilting beam, in order to emit the radio wave in a cell effectively and preventing the radio wave from leaking in a region other than the cell. It is necessary to increase the tilt of the main beam greatly, in accordance with increase in height from the earth of the mobile communication base station antenna 1 and decrease in size of the cell. More concretely, in the embodiment, a tilt angle with respect to a horizontal plane of the first array antenna 10 and the second array antenna 12 (i.e. XY plane in FIG. 1A) is tilted with a predetermined angle by electric tilting. For example, the tilt angle is set to be 10° or more, preferably 12° or more. It is possible to generate a depression in a front-direction directivity while keeping the symmetry of the horizontal plane directivity of the main beam by setting the tilt angle to be greater than the predetermined angle.

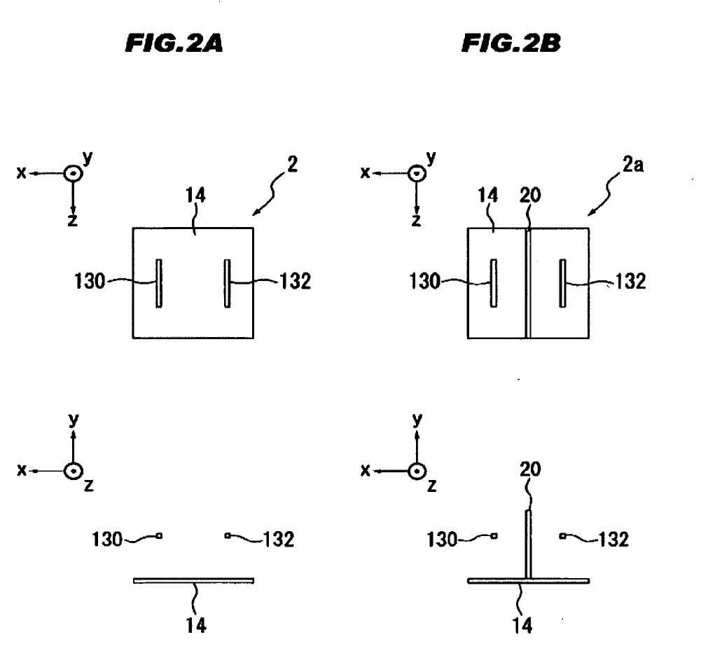

FIG. 2A is a schematic diagram showing a mobile communication base station antenna without shield plate and FIG. 2B is a schematic diagram showing a mobile communication base station antenna with a shield plate.

When two array antennas are juxtaposed in the horizontal direction, it becomes difficult to securely provide isolation between the antenna elements. As a result, it is demanded that a distance between the two array antennas is increased, so that the occupation area for installing the antenna may be increased.

Herein, since the shield plate 20 extending along the y-direction is provided between the first array antenna 10 and the second array antenna 12 in the mobile communication base station antenna 1 in the embodiment, the isolation between the antenna elements can be improved. According to this structure, it is not necessary to increase the distance between the two array antennas. Further, it is possible to suppress the increase in the occupation area for installing the antenna.

Referring to FIGS. 2A and 2B, improvement in effect of the isolation between the antenna elements provided by the shield plate 20 will be explained more concretely.

Referring to FIG. 2A, a mobile communication base station antenna 2 does not comprise a shield plate 20, but further comprises a vertical polarized wave antenna element 130 connected to a feeding point, a vertical polarized wave antenna element 132 connected to a 50-ohm terminal, and a reflective plate 14.

On the other hand, referring to FIG. 2B, a mobile communication base station antenna 2a comprises a shield plate 20, and further comprises a vertical polarized wave antenna element 130 connected to a feeding point, a vertical polarized wave antenna element 132 connected to a 50-ohm terminal, and a reflective plate 14. The reflective plate 14 and the shield plate 20 are electrically connected to each other.

A simulation result of a coupling quantity between the vertical polarized wave antenna element 130 and the vertical polarized wave antenna element 132 in the mobile communication base station antenna 2 was −9.0 dB. On the other hand, a simulation result of a coupling quantity between the vertical polarized wave antenna element 130 and the vertical polarized wave antenna element 132 in the mobile communication base station antenna 2a was −27.1 dB. Therefore, it was confirmed that the isolation between the vertical polarized wave antenna elements was largely improved by providing a metal shield plate 20 between the adjacent vertical polarized wave antenna elements, so that it is not necessary to increase the distance (spacing) between the adjacent vertical polarized wave antenna elements.

In other words, by providing the mobile communication base station antenna 1 with the shield plate 20, it is possible to provide a mobile communication base station antenna 1 comprising two dual-polarized wave array antennas (i.e. the first array antenna 10 and the second array antenna 12) without increasing the occupation area for installing a conventional mobile communication base station antenna.

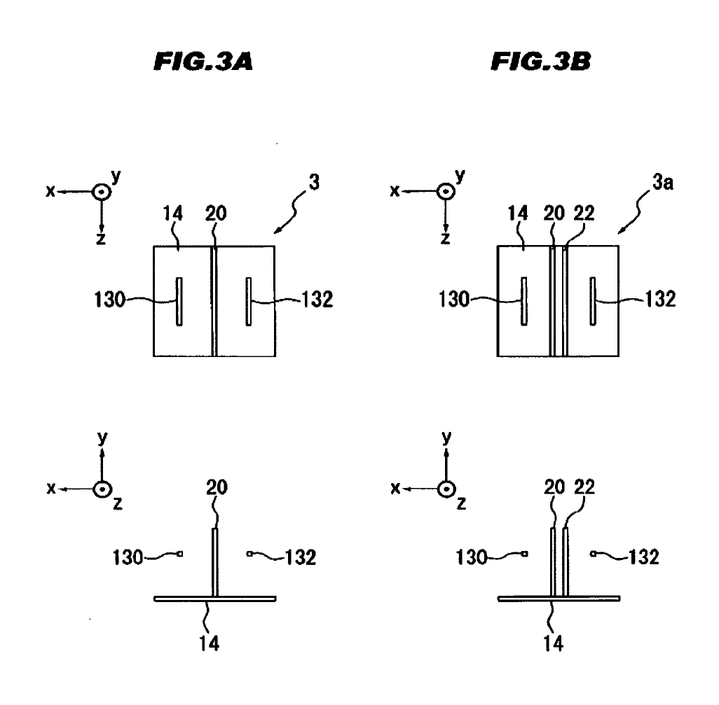

FIG. 3A is a schematic diagram showing a mobile communication base station antenna with a single shield plate, and FIG. 3B is a schematic diagram showing a mobile communication base station antenna with two shield plates.

In a mobile communication base station antenna, the isolation between the antenna elements can be improved by juxtaposing two shield plates in the horizontal direction. Referring to FIGS. 3A and 3B, effect of improving the isolation between the antenna elements by arranging two shield plates 20 will be described below in more detail.

Referring to FIG. 3A, a mobile communication base station antenna 3 comprises one shield plate 20, and further comprises a vertical polarized wave antenna element 130 connected to a feeding point, a vertical polarized wave antenna element 132 connected to a 50-ohm terminal, and a reflective plate 14. The reflective plate 14 and the shield plate 20 are electrically connected to each other.

On the other hand, referring to FIG. 3B, a mobile communication base station antenna 3a comprises two shield plates 20, 22, and further comprises a vertical polarized wave antenna element 130 connected to a feeding point, a vertical polarized wave antenna element 132 connected to a 50-ohm terminal, and a, reflective plate 14. The reflective plate 14 and the shield plates 20, 22 are electrically connected to each other.

A simulation result of a coupling quantity between the vertical polarized wave antenna element 130 and the vertical polarized wave antenna element 132 in the mobile communication base station antenna 3 was −27.1 dB. On the other hand, a simulation result of a coupling quantity between the vertical polarized wave antenna element 130 and the vertical polarized wave antenna element 132 in the mobile communication base station antenna 3a was −29.2 dB. Therefore, it was confirmed that the isolation between the vertical polarized wave antenna elements was further improved by providing two shield plates between the adjacent vertical polarized wave antenna elements, so that it is not necessary to increase the distance (spacing) between the adjacent vertical polarized wave antenna elements.

In other words, by providing the mobile communication base station antenna 1 with the two shield plates, it is possible to further improve the isolation between the antenna elements, and to provide a small-sized mobile communication base station antenna comprising a plurality of array antennas.

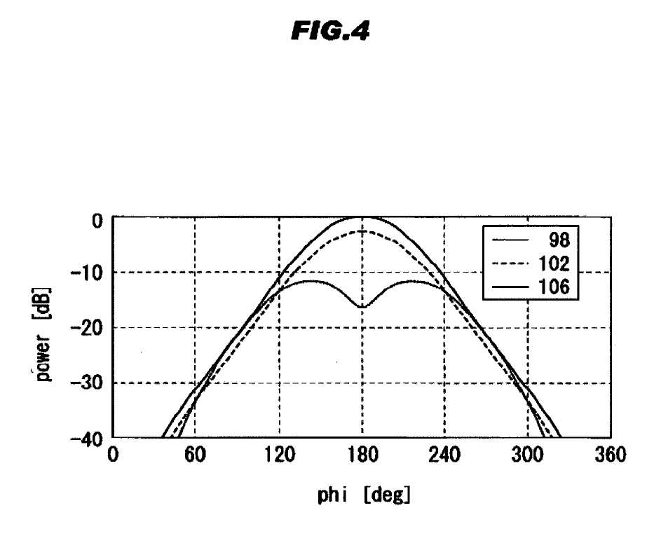

FIG. 4 is a graph showing directivities in a horizontal plane of the mobile communication base station antenna having different cut plane in the embodiment according to the present invention.

Next, a mobile communication base station antenna 1 comprising a first array antenna 10 having ten (10) antenna element pairs 100 and a second array antenna 12 having and ten (10) antenna element pairs 120 will be explained below. In the following explanation, the first array antenna 10 and the second array antenna in the mobile communication base station antenna 1 may be referred to as “ten (10)-element array antenna”.

According to element arrangement of the array antenna in the mobile communication base station antenna 1, horizontal plane directivities as shown in FIG. 4 are obtained. The maximum radiation direction is a direction of (horizontal angle φ, vertical angle θ)=(180°, 98°, and tilted with an angle of 8° toward the earth side from the horizontal direction. The symmetry of the beam on the right and left sides is excellent in horizontal planes (cut plane θ=102° and 106°) other than a horizontal plane (cut plane θ=98°) including the maximum radiation direction (the direction in which intensity of transmit signal and receive signal are maximum). In the case that a configuration of power-division and feeding other than mobile communication base station antenna 1 in this embodiment is chosen, the symmetry of the reception power distribution in the horizontal plane of the main beam in the front direction is unbalanced in accordance with deepening of the beam tilt (i.e. the tilt angle toward the earth side from the horizontal direction is increased).

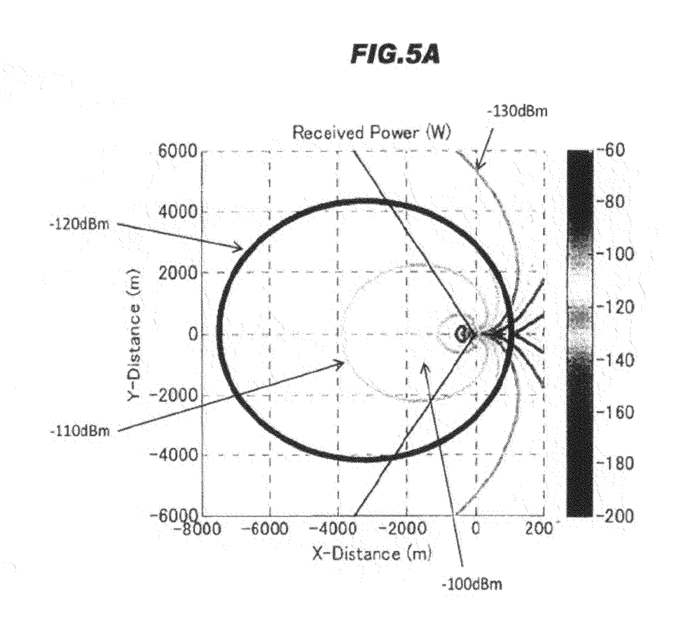

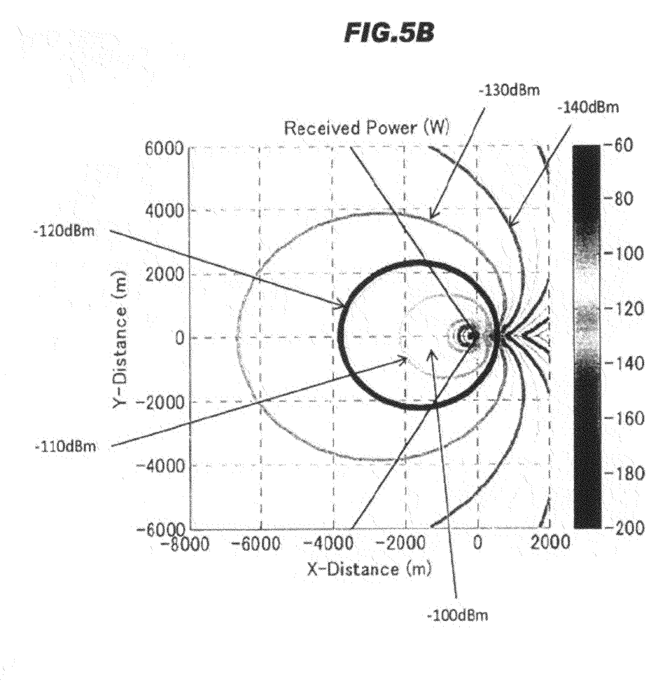

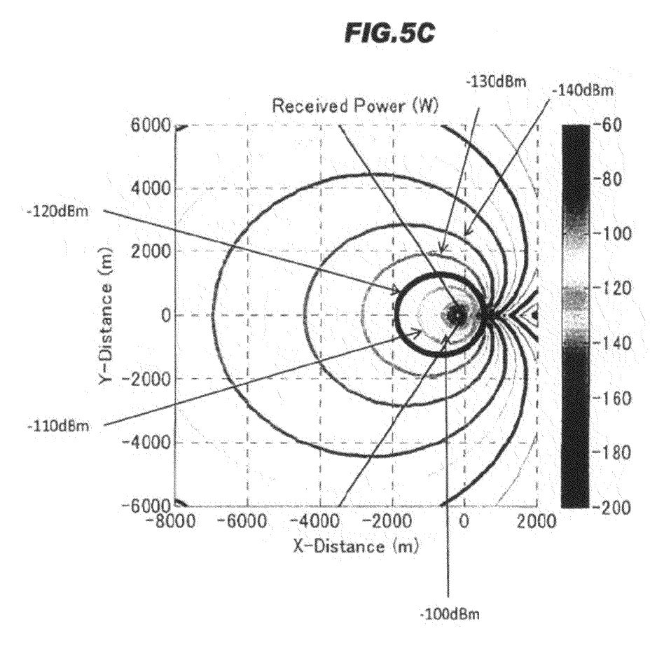

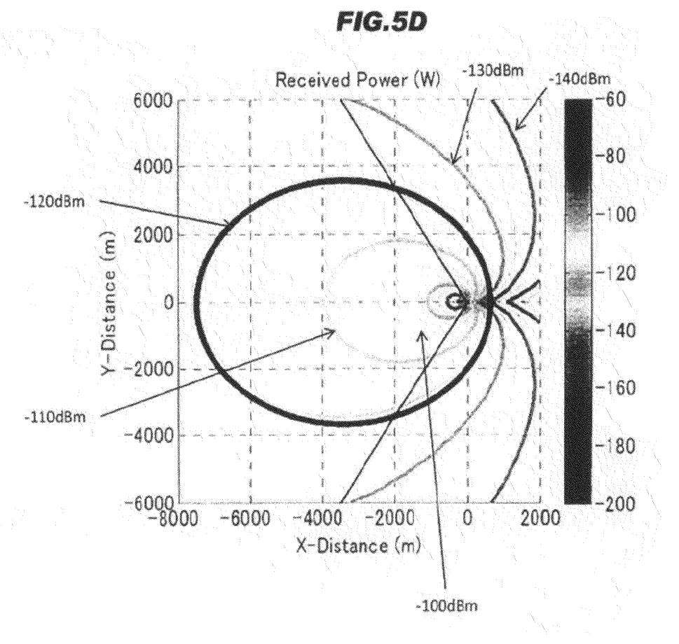

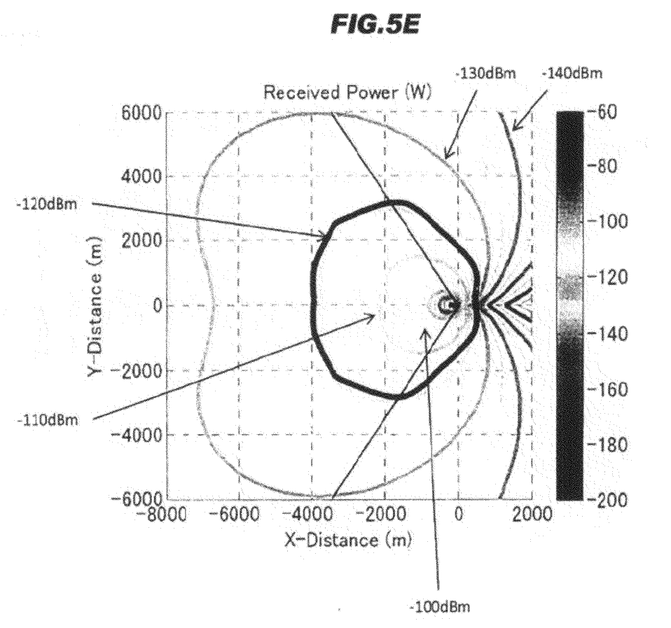

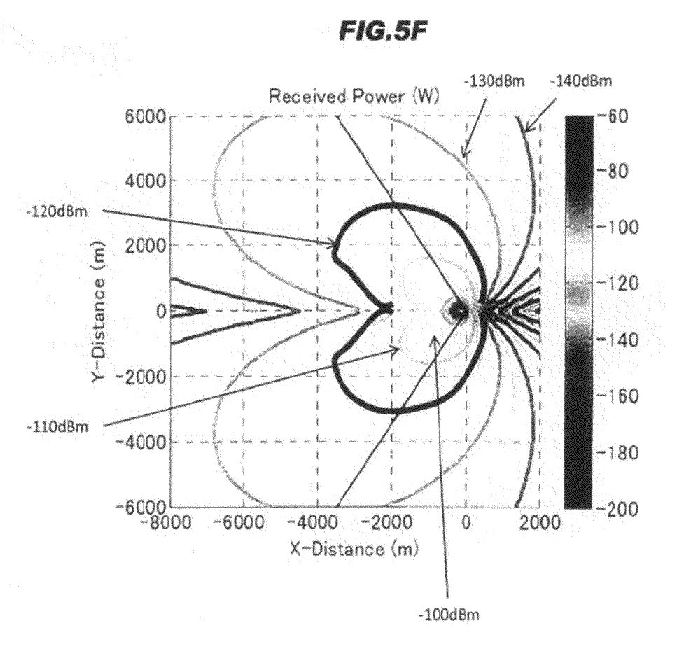

FIGS. 5A to 5F are graph showing a received signal power in a horizontal plane of the mobile communication base station antenna comprising 10-element array antennas in this embodiment.

In other words, FIGS. 5A to 5F show calculation result of service area (reception power distribution of a desired wave) when the disposition and the tilt angle of the 10-element array antennas are changed. In this simulation, as one example, a 10-element array antenna is installed at 50 m high in a micro cell or a macro cell with a calculation area radius of around 6000 to 8000 m and a carrier frequency is 870 MHz.

More concretely, FIG. 5A is a graph showing a received signal power in a horizontal plane when 10-element array antennas in the embodiment are aligned along a straight line to have a tilt angle of 4°. FIG. 5B is a graph showing a received signal power in the horizontal plane when the 10-element array antennas in the embodiment are aligned along a straight line to have a tilt angle of 9°. FIG. 5C is a graph showing a received signal power in the horizontal plane when the 10-element array antennas in the embodiment are aligned along a straight line to have a tilt angle of 12°.

In the linear arrangement (straight arrangement) shown in FIGS. 5A and 5B, the received signal power distribution intensity is reduced (i.e. the distribution of the received signal power intensity is narrowed) in accordance with increase in the tilt angle, while keeping the symmetry of the service area with respect to the installation position of the antenna.

FIG. 5D is a graph showing a received signal power intensity distribution in the horizontal plane when the 10-element array antennas in the embodiment are classified into plural groups (M=3, N=4, and P=3) on the right and left sides respectively to have a tilt angle of 4°. FIG. 5E is a graph showing a received signal power intensity distribution in the horizontal plane when the 10-element array antennas in the embodiment are classified into plural groups (M=3, N=4, and P=3) on the right and left sides respectively to have a tilt angle of 9°. FIG. 5F is a graph showing a received signal power intensity distribution in the horizontal plane when the 10-element array antennas in the embodiment are classified into plural groups (M=3, N=4, and P=3) on the right and left sides respectively to have a tilt angle of 12°. Herein, configuration of arranging the antenna element groups into M=3, N=4, and P=3 on the right and left sides respectively as shown in FIG. 1F is referred to as “3-4-3 arrangement”.

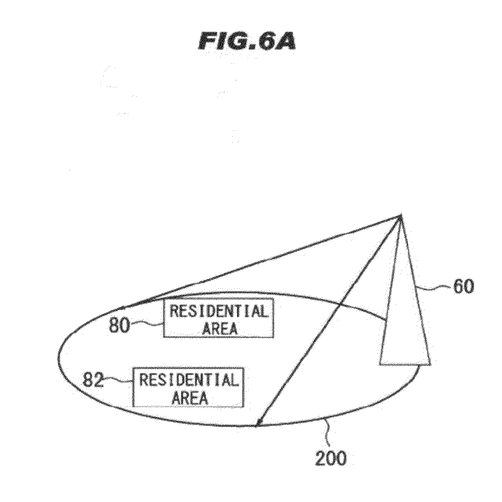

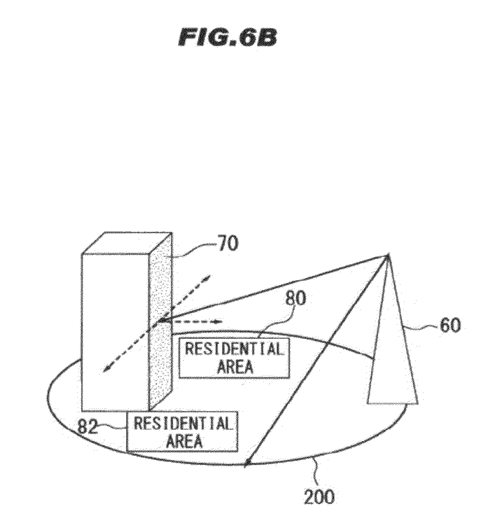

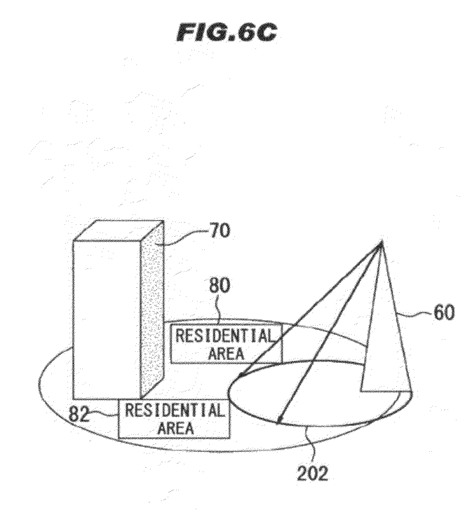

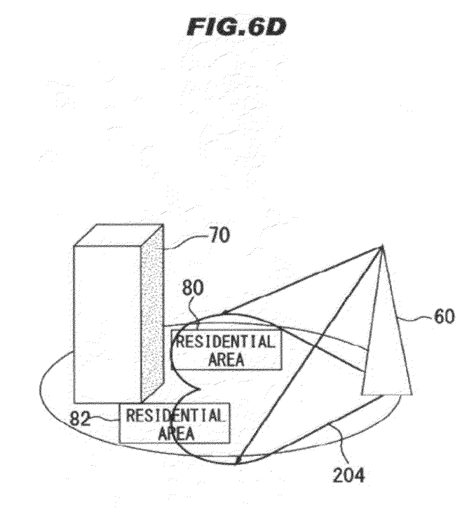

The reception power intensity distribution in the “3-4-3 arrangement” shown in FIGS. 5D to 5F is the same as that in the linear arrangement, when the tilt angle is 4°. However, a slight depression (dent) is found in the reception power intensity distribution in the front direction in the “3-4-3 arrangement”, when the tilt angle is 9°. Further, the reception power intensity distribution in the front direction is completely dented and the service area is heart-shaped in the “3-4-3 arrangement”, when the tilt angle is 12°. FIGS. 6A to 6D are schematic diagrams showing a perspective view of a service area on the ground.

At first, FIG. 6A shows a service area 200 of a base station antenna 60 comprising a conventional mobile communication base station antenna. An oval in FIG. 6A is a level line (contour) to show the same transmit and receive signal intensities (similarly in FIGS. 6B to 6D). The service area 200 includes residential areas 80, 82 to which a desired wave arrives.

Referring to FIG. 6B, when a new building 70 is built in the service area 200, the desired wave is reflected back by the new building 70, and turbulence of transmission of the radio wave occurs in the service area 200.

Then, referring to FIG. 6C, when a base station antenna 60 comprising a mobile communication base station antenna for controlling the tilt angle by a conventional method is used, the service area 200 is narrowed to a service area 202.

On the other hand, FIG. 6D shows a mobile communication base station antenna system in this embodiment. The mobile communication base station antenna system comprises a mobile communication base station antenna 1, and receives signals at a predetermined frequency from a predetermined service area. For example, the mobile communication base station antenna system comprises the mobile communication base station antenna 1 and a base station antenna 60 having the mobile communication base station antenna 1, and the mobile communication base station antenna 1 receives signals at a predetermined frequency transmitted from a communication terminal including a mobile communication terminal in a predetermined service area.

Referring to FIG. 6D, the base station antenna 60 comprising the mobile communication base station antenna 1 in this embodiment can lower the transmit and receive signal intensity in the front direction of the base station antenna 60, so that a service area 204 will have a heart-shape. Therefore, it is possible to prevent a large reduction in the service area in a surrounding (neighboring) area. In other words, the mobile communication base station antenna 1 has characteristics in which the directivity in an area distant from a front of the mobile communication base station antenna 1 is not largely changed.

Namely, it is possible to suppress the transmit and receive signal intensity only for the service area of the front direction of the mobile communication base station antenna 1 without suppressing in the transmit and receive signal intensity of the area in the front direction except the service area, by setting the tilt angle of the mobile communication base station antenna 1 to be greater than the predetermined angle. In addition, a plurality of propagation paths of signals can be formed by setting the tilt angle to be greater than the predetermined angle, thereby improving the effect of the MIMO.

### Effects of the Embodiment

According to the mobile communication base station antenna 1 in this embodiment, the electric power can be divided and fed to the respective antenna elements with a good balance, the beam (including a side lobe) can be radiated with good balance in the front direction of the mobile communication base station antenna 1. Accordingly, it is possible to keep the symmetry of the service area (in other words, the transmit and receive signal intensity distribution of the desired wave). Further, it is possible to suppress the leak and the interference of the radio wave while keeping the symmetry of the transmit and receive signal intensity distribution in the horizontal plane of the front direction of the main beam, even in a location where it is difficult to prevent the leak or interference of the radio wave by merely deepening the beam tilt.

In other words, according to the mobile communication base station antenna 1 in this embodiment, following effect can be obtained, even in the case that a factor of disturbing the area distribution such as construction of a new high-rise building or new base station is generated in a region with an area already set. In such a case, it is possible to remarkably reduce the transmit and receive signal intensity distribution in the horizontal plane of the front direction of the main beam by extremely deepening the beam tilt to be e.g. 12° as in FIG. 5F. Accordingly as shown in a schematic diagram of FIG. 6D, it is possible to suppress the directivity of the main beam in the front direction, thereby preventing the large reduction in the neighboring service areas, when the beam tilt is deep.

Further, according to the mobile communication base station antenna 1 in the embodiment, not only the directivity in the front direction of the antenna can be suppressed, but also the effect of the MIMO in accordance with the directivity variation of the array antenna can be expected.

In other words, the mobile communication base station antenna 1 in this embodiment exhibits the transmit and receive signal intensity distribution as shown in FIG. 5F. The transmit and receive signal intensity distribution in FIG. 5F explicitly shows that the directivity of the array antenna for forming the service area is largely changed. Therefore, it can be understood as if the mobile communication base station antenna 1 formed two propagation paths which cannot be formed without reflection or the like in the conventional device. As a result, according to the mobile communication base station antenna 1 in the embodiment, it is possible to improve a communication capacitance and a communication quality by the effect of the MIMO.

### REFERENCE EXAMPLE 1

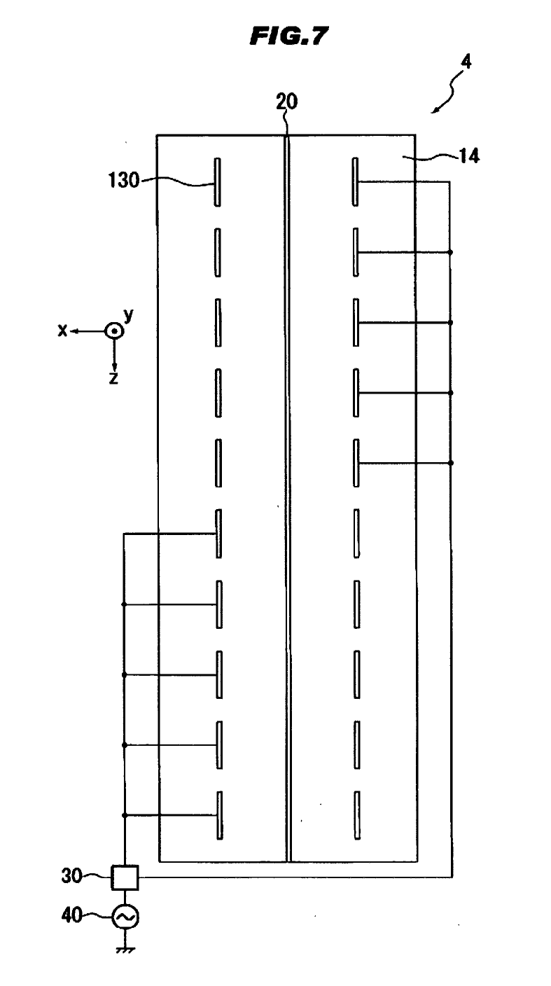

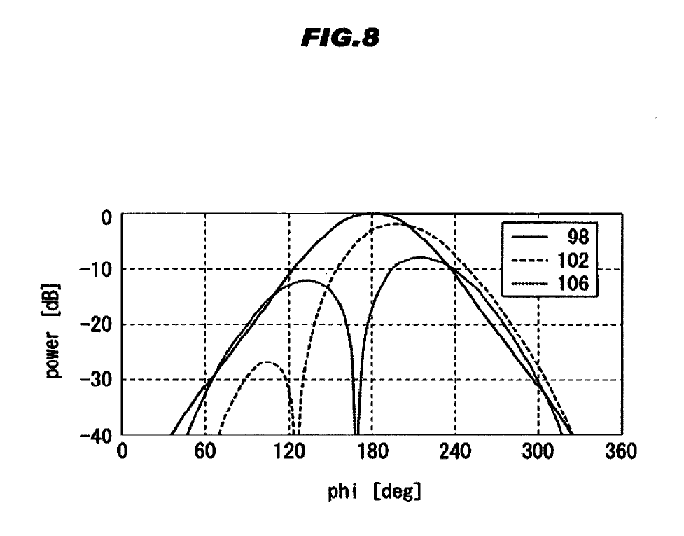

FIG. 7 is a schematic diagram showing an essential structure of a mobile communication base station antenna in a reference example 1. FIG. 8 is a graph showing directivities in a horizontal plane of the mobile communication base station antenna in the reference example 1.

A mobile communication base station antenna 4 in the reference example 1 has substantially similar configuration and function to those of the mobile communication base station antenna 1 in this embodiment, except pattern of the power division feeding. Therefore, detailed description thereof is omitted.

Element arrangement of array antennas as shown in FIG. 7 provides a horizontal plane directivity as shown in FIG. 8. The maximum radiation direction is a direction of (horizontal angle φ, vertical angle θ)=(180°, 98°), and tilted with an angle of 8° toward the earth side from the horizontal direction. The symmetry of the beam on the right and left sides is excellent in a horizontal plane (cut plane θ=98°) including the maximum radiation direction, while the symmetry of the beam on the right and left sides is bad in other horizontal planes (cut plane θ=102° and 106°).

### REFERENCE EXAMPLE 2

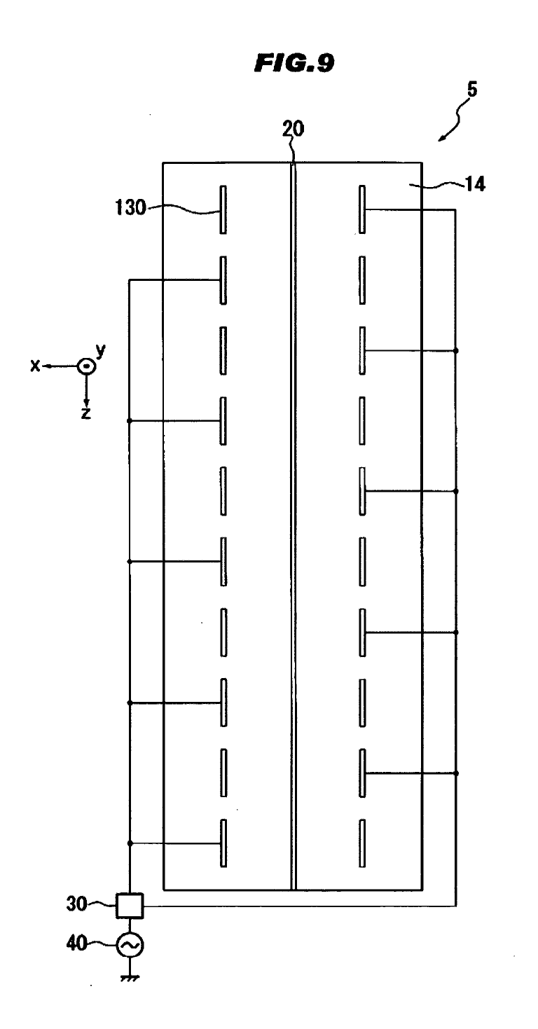

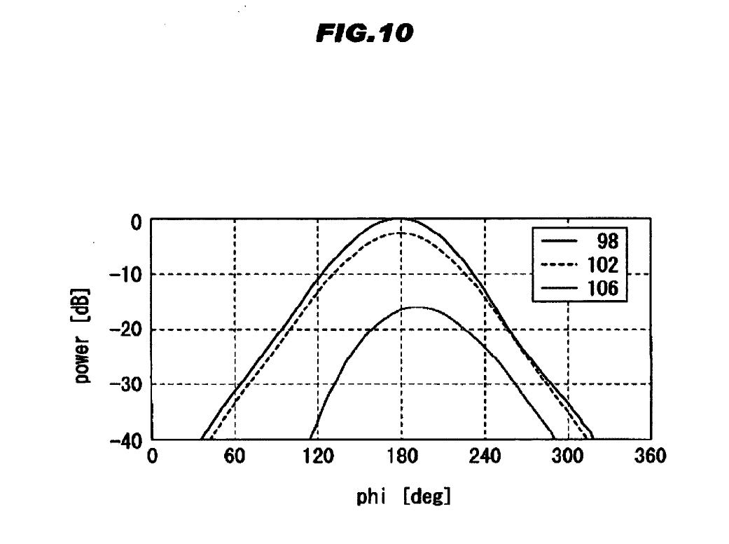

FIG. 9 is a schematic diagram showing an essential structure of a mobile communication base station antenna in a reference example 2. FIG. 10 is a graph showing directivities in a horizontal plane of the mobile communication base station antenna in the reference example 2.

A mobile communication base station antenna 5 in the reference example 2 has substantially similar configuration and function to those of the mobile communication base station antenna 1 in this embodiment, except pattern of the power division feeding. Therefore, detailed description thereof is omitted.

Element arrangement of array antennas as shown in FIG. 9 provides a horizontal plane directivity as shown in FIG. 10. The symmetry of the beam in the right and left is excellent in a horizontal plane (cut plane θ=98°) including the maximum radiation direction, while the symmetry of the beam on the right and left sides is slightly bad in other horizontal planes (particularly in a cut plane θ=106°).

Comparing the reference example 1 and the reference example 2 with this embodiment, following effect is confirmed. In the mobile communication base station antenna 1 in this embodiment, since a plurality of antenna element pairs of the two array antennas are classified into a first group comprising M-antenna element pairs, a second group comprising N-antenna element pairs, and a third group comprising P-antenna element pairs from one end to another end of each of first and second array antennas (M, N, and P are positive integers, respectively), and the electric power is divided and fed to the antenna elements of the respective groups with a good balance, so that it is possible to radiate the beam including the side lobe in the front direction of the mobile communication base station antenna 1.

Although the invention has been described, the invention according to claims is not to be limited by the above-mentioned embodiments and examples. Further, please note that not all combinations of the features described in the embodiments and the examples are not necessary to solve the problem of the invention.

What is claimed is:

1. A mobile communication base station antenna comprising:
two array antennas juxtaposed in a horizontal direction, each of the array antennas including a plurality of antenna element pairs arranged in a vertical direction, each of the antenna element pairs comprising two antenna elements having polarization characteristics perpendicular to each other; and
a shield plate provided between the two array antennas;
wherein the plurality of antenna element pairs of each of the two array antennas are classified into a first group comprising M-antenna element pairs, a second group comprising N-antenna element pairs, and a third group comprising P-antenna element pairs from one end to another end of the two array antennas (M, N, and P are positive integers, respectively),
wherein an electric power is fed from one feeding point to the antenna elements of the first and third group of one of the two array antennas and the antenna elements of the second group of another of the two array antennas,
wherein a tilt angle of the two array antennas with respect to a horizontal plane is set to be a predetermined tilt angle by electrical tilting.

2. The mobile communication base station antenna according to claim 1, wherein the tilt angle is 10° or more.

3. The mobile communication base station antenna according to claim 2, wherein the shield plate has a height greater than a height of the antenna element pairs.

4. The mobile communication base station antenna according to claim 3, wherein the shield plate is formed by using a wave absorber.

5. A mobile communication base station antenna system configured to receive a signal at a predetermined frequency from a predetermined service area, comprising:
a mobile communication base station antenna comprising:
two array antennas juxtaposed in a horizontal direction, each of the array antennas including a plurality of antenna element pairs arranged in a vertical direction, each of the antenna element pairs comprising two antenna elements having polarization characteristics perpendicular to each other; and
a shield plate provided between the two array antennas;
in which the plurality of antenna element pairs of each of the two array antennas are classified into a first group comprising M-antenna element pairs, a second group comprising N-antenna element pairs, and a third group comprising P-antenna element pairs from one end to another end of the two array antennas (M, N, and P are positive integers, respectively),
in which an electric power is fed from one feeding point to the antenna elements of the first and third group of one of the two array antennas and the antenna elements of the second group of another of the two array antennas,
in which a tilt angle of the two array antennas with respect to a horizontal plane is set to be a predetermined tilt angle by electrical tilting.

6. The mobile communication base station antenna system according to claim 5, wherein the tilt angle of the mobile communication base station antenna is set to be a predetermined tilt angle by the electric tilt such that a transmit and receive signal intensity for the service area in a front direction of the mobile communication base station antenna is suppressed and a transmit and receive signal intensity of a region except the service area in the front direction is not suppressed.

7. The mobile communication base station antenna system according to claim 5, wherein the tilt angle is set to be a predetermined angle such that a plurality of propagation paths for the signal are formed.
